(19) United States
(12) Patent Application Publication
(10) Pub. No.: US 2012/0247845 A1
(43) Pub. Date: Oct. 4, 2012

(54) TROLLEYS

(76) Inventor: Antony John Webb, Canterbury (GB)

(21) Appl. No.: 13/075,526

(22) Filed: Mar. 30, 2011

(51) Int. Cl. B60K 1/04

(52) U.S. Cl. 180/65.1

(57) ABSTRACT

The present invention is an electrically powered golf trolley with a battery 15 supplying electrical current for powering the trolley and an electrical connection interface 18 through which a separate portable electrical component is electrically coupled to the battery. The electrical connection interface is a plug or socket (such as a USB socket) to which a cooperating part on the portable electrical component is connectable. The handle 16 of the trolley may further comprise means to support the portable electrical component whilst it is connected to the electrical connection interface. There may be voltage or current alteration means between the battery and the electrical connection interface to regulate the electrical output therefrom.

The present invention relates to electrically powered sports trolleys.

It is known to use trolleys for the convenient transport of sporting equipment before, during or after play. Such trolleys or carts are collectively herein referred to as sports trolleys. These may or may not also transport people, but the present invention is particularly concerned with those that are not intended to carry people. A particular common example of this is golf trolleys which are designed to assist in the transportation of golf bags and golf clubs as a player moves around a course. To assist in the movement of such trolleys around a course it is well known for them to be provided with electrical motors adapted to drive the wheels. Batteries are provided in order to supply the electric motor or motors with the necessary electrical current to operate.

It is increasingly common these days for sportsmen to use portable electronic equipment either as part of the sport or simply personal use whilst playing or during appropriate pauses. Such equipment may include for example mobile phones, MP3 players, PDAs and the like. In some sports, particularly golf, equipment such as GPS receivers are used in order to monitor a golfer's position on a course and provide useful data such as distance to the hole.

It has been found that the batteries employed in powered such trolleys have ample capacity to assist in powering portable peripheral devices when in use. Therefore, it is an aim of the present invention to provide a mechanism by which portable electronic devices may be powered from the trolley's power source to ensure sufficient duration of operation.

Therefore, according to the present invention there is provided an electrically powered sports trolley, comprising a battery supplying electrical current for powering the trolley and an electrical connection interface through which a separate portable electrical component may be electrically coupled to the battery.

The present invention may be applied to any situation in which a trolley with electrical power is utilised in an appropriate sport. However, it is particularly advantageous in respect of the sport of golf and therefore it is highly preferred that the trolley is a golf trolley. Such a golf trolley, in addition to the features previously mentioned, would be provided with a means to support a golf bag. Further, one or more electric motor and appropriate controllers may be provided to drive wheels on the trolley as is well known.

The electrical connection interface may be a plug or a socket to which a co-operating part on the portable electrical component is connectable. It is highly preferred that the electrical connection interface on the trolley comprises a USB socket such that any portable device adapted to be charged through a USB connection may be connected and charged and/or powered.

Preferably the trolley includes a handle and the electrical connection interface is provided on or adjacent the handle for ease of connection.

In order that the portable electrical component can be safely located on the trolley whilst connected to the electrical connection interface it is preferred that the trolley further comprises appropriate support means to support the component on the trolley. Such support means might simply take the form of a surface upon which the item can be placed or a hook from which it could be hung. In more preferred embodiments such support means might comprise an appropriately configured bracket or recess into which the electrical component may be securely located. This permits the component to be placed on the trolley, connected to the electrical connection interface and remain so whilst the trolley is moving over potentially uneven terrain. Advantageously the electrical connection interface is provided closely adjacent to any such support means. Potentially the electrical connection means and support means may be configured such that location of an electrical component within the support means automatically causes an electrical connection between the electrical connection interface and the component.

In addition to the electrical connection between the component and the battery achieving the supply of power to the electrical component it is possible that the connection may also provide a control/data exchange interface between the portable component and any other constituent or device forming part of the trolley. For example, if the portable electrical component is a GPS receiver it is possible that the interface with the trolley could be used to control the movement of the trolley as well as powering the trolley.

In order that it may be better understood, but by way of example only, an embodiment of the present invention will now be described in more details with reference to the accompanying drawings in which:

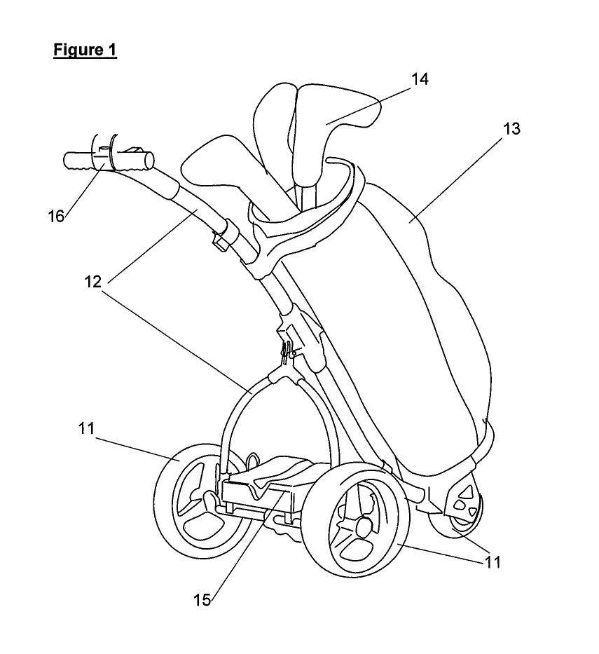

FIG. 1 is a perspective view of an embodiment of trolley according to the present invention; and

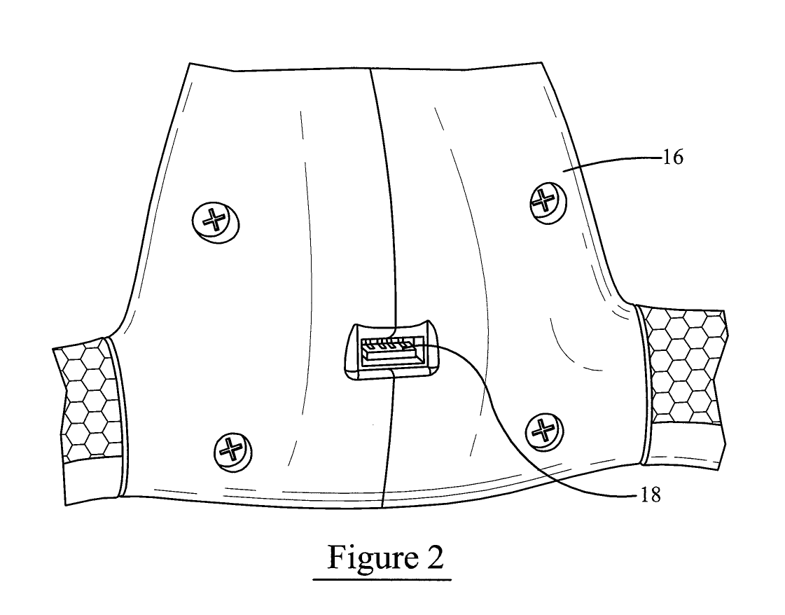

FIG. 2 is an enlarged underside view of the handle showing the electrical connection interface.

Referring to FIGS. 1 and 2, there is shown an embodiment of golf trolley according to the present invention. The trolley generally comprises a frame 10 supported by three wheels 11 which allow the trolley to roll over the ground. A golf bag 13 is supported on the framework 10 and carries golf clubs 14 for use whilst playing. The frame supports a battery pack 15 which powers motors that drive the rear wheels 11. These rear wheels are configured such that a separate motor drives each wheel therefore allowing independent control of the two rear wheels and as a consequence the direction of the trolley's movement.

At the upper end of the frame is a handle 16 which can be used to manoeuvre the trolley. If appropriate, control mechanisms for the drive motors may be located in the handle. On the underside of the handle (best seen in FIG. 2) there is an electrical connection interface in the form of a universal serial bus (USB) type connector 18. This connector is provided on the underside of the handle to ensure minimum visual impact when not in use and to help protect it from adverse climatic conditions. A protective cap (not shown) may also be provided to improve protection from the environment.

When a golfer wishes to connect a portable electronic component (not shown) the golfer removes any the protective cap from the USB connector 18 and engages an interface lead (not shown) provided with the electrical component into the USB port at one end and the electrical component at the other (if not permanently integrated). The electrical component is then supported on the handle of the trolley. The support means to hold the electrical component are not shown in the accompanying drawings. The golfer may then manoeuvre the trolley normally whilst the electrical component is supported and is powered and/or charged by electrical supply from the battery pack 15.

Given that the battery pack could operate at a voltage, such as 12 volts, that may be different to the desired USB output voltage, suitable regulatory electronic components are provided within the handle (and are not visible in the attached) in order to regulate the output from the USB port. Wires extend within the frame from the battery pack to the USB port and or regulatory components.

1. An electrically powered sports trolley, comprising a battery supplying electrical current for powering the trolley and an electrical connection interface through which a separate portable electrical component may be electrically coupled to the battery.

2. A trolley as claimed in claim 1, which is a golf trolley.

3. A trolley as claimed in claim 1, in which the electrical connection interface is a plug or socket to which a cooperating part on the portable electrical component is connectable.

4. A trolley as claimed in claim 3, wherein the electrical connection interface is a USB socket.

5. A trolley as claimed in claim 1, which further comprises means to support the portable electrical component whilst connected to the electrical connection interface.

6. A trolley as claimed in claim 1, which further comprise current and or voltage alteration means between the battery and the electrical connection interface to regulate the electrical output therefrom.
